(19) United States
(12) Patent Application Publication
(10) Pub. No.: US 2004/0243449 A1
(43) Pub. Date: Dec. 2, 2004

(54) Automated dealership data extraction and insurance processing system and method

(76) Inventors: Michael Neustadt, Encino, CA (US); Paul Kane, Encino, CA (US); David Diem, Encino, CA (US); Jack Edelstein, Encino, CA (US); Robert Humphreys, Encino, CA (US)

Correspondence Address: Albin H. Gess, SNELL & WILMER L.L.P., Suite 1200, 1920 Main Street, Irvine, CA, 92614-7230, US

(21) Appl. No.: 10/449,958

(22) Filed: May 30, 2003

(51) Int. Cl. G06F 17/60

(52) U.S. Cl. 705/4

(57) ABSTRACT

A system and method to automatically trigger data extraction from a Dealerships Management System (DMS) and transmitting it to an insurance service provider for automatic, real-time, generation of insurance application. Generally, an indicator is generated that a customer needs automobile insurance at a point-of-sale. The indicator causes the automatic extraction of the customer's information from a database. The extracted customer information is transmitted to a remote computer for automatic insurance fulfillment. Upon receiving the customer's information, the remote computer automatically populates the appropriate fields of an insurance application and transmits the insurance application to the customer. Upon approval of the insurance application by the customer, a confirmation of insurance is sent to the customer.

### FIELD OF THE INVENTION

Various embodiments of the invention pertain to automated data extraction. More particularly, at least one embodiment of the invention relates to a system and method for automated extraction of customer and/or vehicle information necessary for insurance and/or warranty transactions.

### DESCRIPTION OF RELATED ART

Insurance is typically required for any financed or leased automobile purchased at a dealership in the United States today. Some statistics suggest that 10-15% of vehicle buyers in dealerships are typically uninsured at the point-of-sale and, therefore, unable to take immediate delivery of the vehicle. These motorists are primarily first-time drivers with no previous insurance, those whose coverage has lapsed, or those considered higher risk motorists based on their previous driving record. Traditional solutions for solving this problem are antiquated and contain numerous pitfalls and are geographically limited and regional in nature.

Today, the dealership industry is experiencing rapid consolidation into large, highly competitive, multi-state dealer groups, which has heightened demand for a professional, standardized solution for point-of-sale automobile insurance and other warranty services and related aftermarket products.

Historically, when a vehicle buyer does not have either a current insurance policy, or proof of insurance at the point of sale, the consumer often obtains insurance at the dealer either through an independent insurance agent or through a fax system.

The Independent Agent System is a commonly used method of arranging automobile insurance in dealerships across the country. Under this model, the customer is manually referred to an insurance agent who is summoned when a sales representative from an automobile dealership has a prospective car buyer who does not have car insurance. Unfortunately, the majority of car sales occur during the evening and weekend hours, often late into the night, after normal business hours. If an independent agent is available, the agent typically arrives twenty (20) to ninety (90) minutes later and takes another thirty (30) to forty (40) minutes to manually obtain the customer and vehicle information and manually complete an application. Independent agents, as well as certain regional agencies, work in this manner.

Another referral method that is used is to refer the customer to the independent agent by telephone. In this scenario, the customer can speak directly to an agent and manually provide the vehicle and customer information over the telephone while the agent manually completes an insurance application with this information. Unfortunately, this method suffers from both the lack of evening and weekend availability as well as remains time consuming and inefficient for the dealership, customer and insurance agent.

Another method of securing point-of-sale insurance is the “fax” method in which the dealer representative completes and submits an insurance application containing the customer and vehicle information via facsimile to an authorized agent or carrier for approval. Unfortunately, this often involves the dealership and dealer representative handling certain aspects of the process. Since insurance regulations in most states do not allow dealership personnel to get involved in the solicitation, transaction or effectuation of insurance without an insurance license, obtainment of which is not practical in most states, the fax back method can only be used in a few states where insurance regulations allow it.

As a result, conventional methods of obtaining insurance at the point-of-sale delay a purchaser's receipt of a car which is undesirable for both the customer and the dealership.

### DESCRIPTION OF THE DRAWINGS

FIG. 1 illustrates a front side perspective view of the color coordination kiosk cabinet according to one embodiment of an aspect of the invention.

FIG. 2 illustrates an embodiment of a data extraction system in which a local computer is used to extract data from the Dealer Management System (DMS) and transmit it to the insurance provider.

FIG. 3 illustrates another embodiment of a data extraction system in an application or agent on the DMS server is used to extract data from the DMS and transmit it to the insurance provider.

FIG. 4 illustrates yet another embodiment of a data extraction system in which a dedicated computer is used to extract data from the DMS and transmit it to the insurance provider.

FIG. 5 illustrates a “referral” method of providing insurance according to one implementation of the invention.

FIG. 6 illustrates an “online” method of providing insurance according to one implementation of the invention.

### DETAILED DESCRIPTION

In the following description numerous specific details are set forth in order to provide a thorough understanding of the invention. However, one skilled in the art would recognize that the invention may be practiced without these specific details. In other instances, well known methods, procedures, and/or components have not been described in detail so as not to unnecessarily obscure aspects of the invention.

In the following description, certain terminology is used to describe certain features of one or more embodiments of the invention. For instance, “network” includes any communication link between two or more devices. The term “database” is used to represent the collection of data in one or more data structures, lists, components, etc. The term “agent” refers to any software and/or hardware component configured to perform certain operations. The term “remote” (e.g., remote computer) refers to a location which is physically distant from a referred location.

One aspect of the invention solves the aforementioned problems and provides an immediate, automated solution that allows the dealership to, figuratively at the push of a button, refer the customer to the insurance agent or company by automatically transferring the necessary customer and vehicle information already in their Dealership Management System (DMS) as a result of the vehicle sale, to the agent or insurance company who automatically receives the information in an electronic format and auto populates an insurance application, all in a matter of seconds.

While various embodiments of the invention relate to an automated data extraction system of buyer and/or vehicle information for generating insurance and/or warranty transactions, the present invention is to be interpreted broadly to cover any data extraction system, application, and/or device for automating transactions.

Various aspects of the invention provide a novel system for an immediate, no wait-time, insurance and/or warranty coverage solution at the point-of-sale that can work with the various business and insurance regulations in each state, which typically limit the dealer's direct involvement in any existing process.

A first aspect of the invention provides a method of automatically triggering data extraction from a dealership's management system and transmitting it to an insurance service provider. For example, customer data and automobile purchase information is extracted from the DMS when a customer does not have the required insurance coverage to take possession of a purchased vehicle.

A second aspect of the invention provides an automatic, real-time, insurance fulfillment system. The information extracted from the DMS is automatically transmitted to the insurance provider where it can be used in several ways to help the customer complete the process of acquiring automobile insurance quickly, efficiently and with minimal involvement of dealership personnel.

One implementation of an embodiment of the invention provides a system and method for automatically referring key data by un-licensed personnel, pre-populating a document online electronic document or automatically generating a paper document at a licensed entity. The system provides real-time communication with an automobile dealership's management system (DMS) for the purpose of transmitting customer and/or vehicle related information. Customer and or vehicle data is extracted from the DMS to automatically receive the data necessary for conducting insurance and warranty commerce.

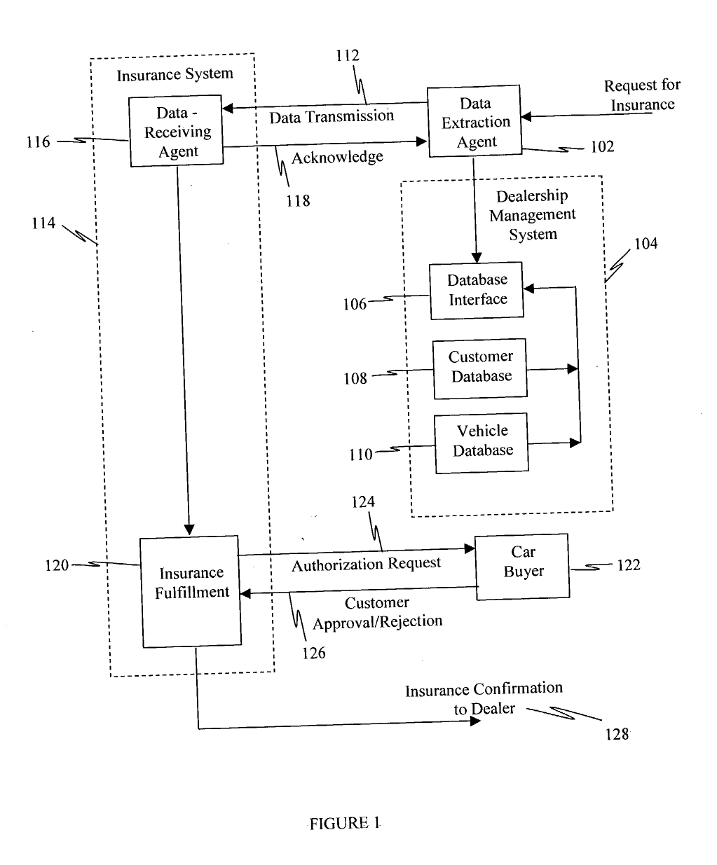

FIG. 1 illustrates a block diagram of a system in which automated data extraction and insurance fulfillment may be implemented according to one implementation of the invention.

At an automobile dealership, a car buyer's information is entered and/or stored in the DMS 104. Information about the vehicle being purchased, such as the vehicle identification number, may also be entered and/or stored in the DMS 104.

As part of the car sales process, when a car buyer needs insurance coverage the dealer can indicate this in a number of ways. For example, the salesperson may use a hot-key (e.g., Control-A, Control-B, etc.) on a computer to indicate that the buyer does not have insurance coverage. The hot-key may trigger a data extraction agent 102 which communicates with the DMS 104 via a database interface 106 to extract data from a customer information database 108 and/or a vehicle information database 110. The data extraction agent 102 extracts the data relevant to the buyer and the buyer's vehicle and transmits it 112 to the insurance provider's system 114.

This data extraction architecture permits the dealer to control access to its databases 108 and 110, releasing only that information which the dealer deems necessary for insurance purposes. In the system illustrated above, the insurance provider never accesses the dealer's, database or management system but is instead provided with the necessary buyer and vehicle information by the data extraction agent which resides on the dealer's facilities. In other implementations, the dealer may permit an insurance provider direct access to its databases and/or management system to extract buyer and/or vehicle information.

The insurance provider 108 may be communicatively linked to the DMS 102 over a share or dedicated transmission medium 112 (e.g., the Internet, dial-up modem, telephone line, wireless link, dedicated connection, etc.).

At the insurance provider's system 114, the data is received from the dealer by a data-receiving agent 116. According to one implementation of the invention, the data-receiving agent 116 acknowledges 118 receipt of the data received from the data extraction agent 102. The data-receiving agent 116 then transfers the received data to an insurance fulfillment module 120.

The insurance fulfillment module 120 uses the received data to automatically populate or fill-out an automobile insurance application. The insurance fulfillment module 120 then transmits the insurance application to the buyer 122 for authorization 124. Since the insurance provider generates the insurance application in real-time and with few delays at the point-of-sale, the insurance form may be sent to the dealer where the buyer 122 may review it.

After reviewing the insurance application, the buyer 122 may accept or decline coverage 126. For example, the buyer may sign the insurance application and transmit it back to the insurance provider 114 to indicate acceptance.

Upon receipt of an accepted or signed insurance application, the insurance provider 114 provides insurance confirmation to the dealer 126. Thus, a car buyer may obtain insurance coverage in just moments and take delivery of the vehicle without undue delay.

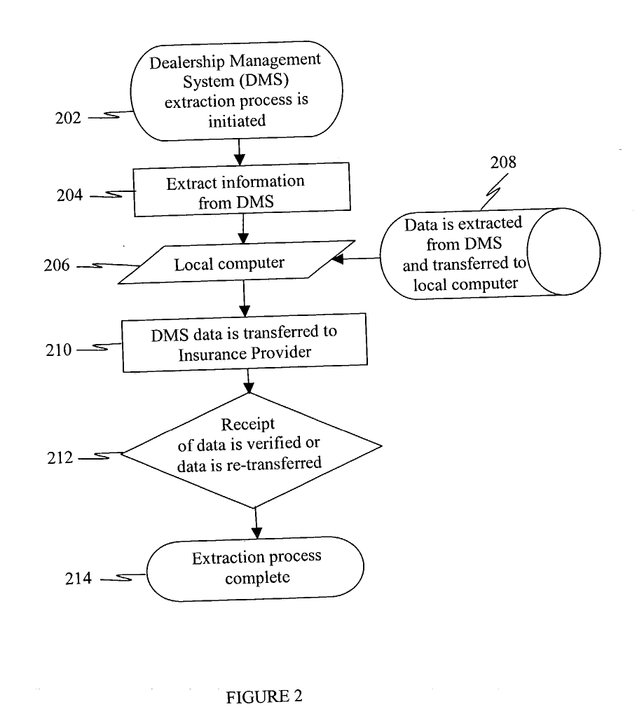

Due to regulatory restrictions in the sale of automobile insurance, it is often necessary to limit the dealer's involvement in assisting their customers with obtaining insurance to that of a referral. FIGS. 2-4 illustrate various different ways in which a dealer may refer by initiating data extraction and transferring the data with limited dealer involvement.

FIG. 2 illustrates an embodiment of a data extraction system in which a local computer is used to extract data from the DMS and transmit it to the insurance provider. When triggered by some indicator (e.g., hot-key, etc.) that insurance is needed, the DMS data extraction process is started 202. A data extraction command 204 is generated to retrieve particular information (e.g., customer data, vehicle information, etc.) from the DMS. In various embodiments of the invention, the data extraction agent 102 (FIG. 1) and/or data extraction command 204 may be executed on a local computer at the dealership, a remote computer, a dedicated computer at the dealership, or the DMS server.

In the embodiment shown in FIG. 2, a local computer 206 is used to access a server 208 where the DMS resides. The servers 208 hosts the DMS and stores data including customer and vehicle information. The local computer 206 retrieves the requested data from the DMS 208 and transmits it to the insurance provider's system. Receipt of the transmitted data by the insurance provider's system is verified, and if not received, it is retransmitted 212. The extraction process ends 214 upon verification that the data was received by the insurance provider's system.

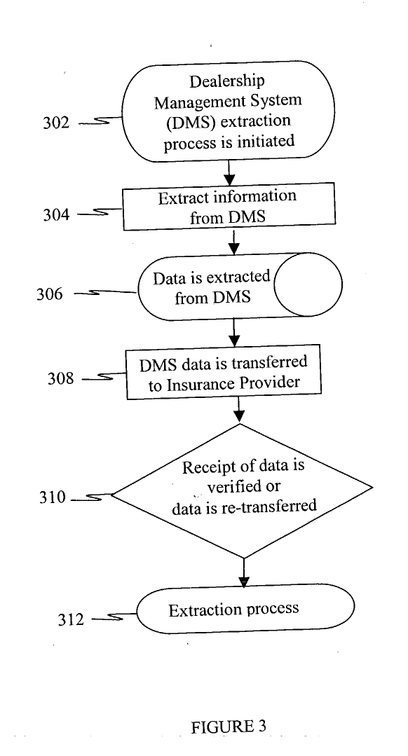

FIG. 3 illustrates another embodiment of a data extraction system in an application or agent on the DMS server used to extract data from the DMS and transmit it to the insurance provider. As in the example of FIG. 2, the DMS extraction process is started upon an indication by the dealer or customer 302. A data extraction command 304 is generated within the DMS server to retrieve or extract particular information (e.g., customer data, vehicle information, etc.) from the DMS database 306. The retrieved information is automatically transmitted to the insurance provider 308. Upon successful verification of receipt by the insurance provider 310, the process ends 312.

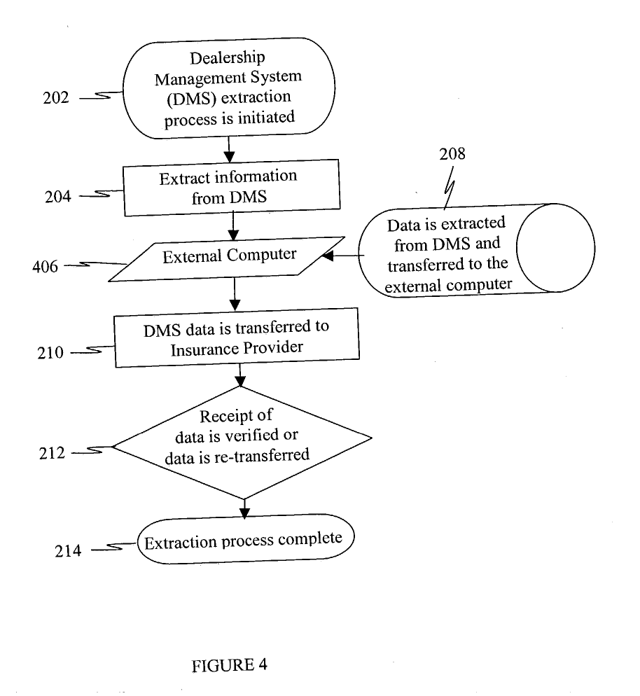

FIG. 4 illustrates yet another embodiment of a data extraction system in which a dedicated computer is used to extract data from the DMS and transmit it to the insurance provider. This embodiment is a variation of the embodiment illustrated in FIG. 2. Rather than using a local computer 206, which may have other uses and/or execute other applications, a dedicated or external computer 406 is used. Such external computer 406 may provide greater security in transmitting data between the dealer and the insurance provider. Additionally, the external computer 406 may also provide greater reliability in generating automatic insurance applications.

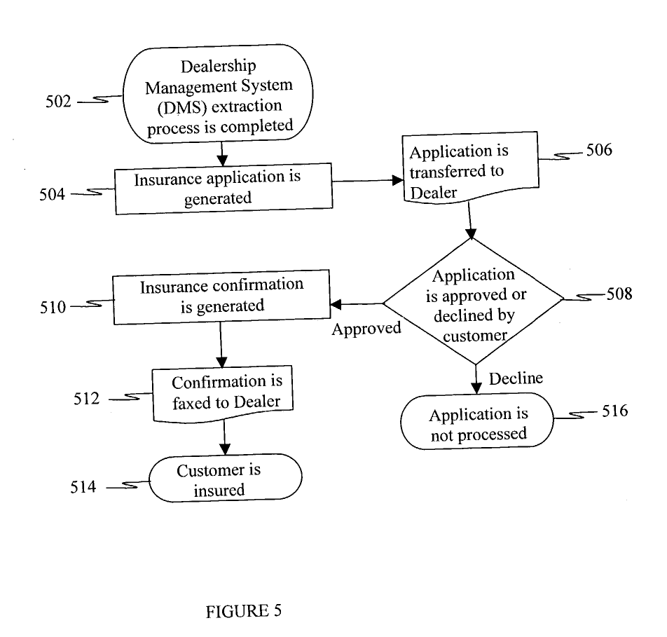

FIG. 5 illustrates a “referral” method of providing insurance according to one implementation of the invention. The referral model allows dealers to refer customers to the insurance provider during the vehicle purchasing process. Once the necessary data has been extracted from the DMS and received by the insurance provider's system 502 (as in the system illustrated in FIGS. 2-4), the data is used to automatically populate and generate an insurance application 504. The insurance application, with most or all necessary information already filled-in, is immediately transmitted back to the customer at the dealership 506. The customer approves the application (e.g., signs it, reviews the information, etc.) and transmits it back (e.g., fax, email, etc.) to the insurance provider 510. When the approved insurance application is received by the insurance provider, an insurance confirmation or evidence of insurance is automatically generated and sent (e.g., faxed, emailed, etc.) to the dealer 512. Upon receipt of the said confirmation, the customer has the necessary insurance 514 to take the purchased vehicle. If the customer declines the application, the application is not processed 516.

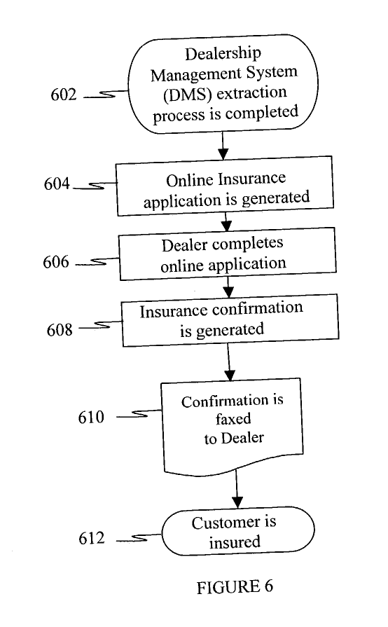

FIG. 6 illustrates an “online” method of providing insurance according to one implementation of the invention. Once the necessary data has been extracted from the DMS (e.g., customer data, vehicle information, etc.) and received by the insurance provider's system 602 (as in the system illustrated in FIGS. 2-4), the data is used to automatically pre-populate an online web-based insurance application 604. Because a majority of the required information is pre-populated, the customer or dealer, depending upon state regulations and policy type, can easily and quickly complete the application 606. Insurance confirmation (e.g. evidence of insurance) is generated 608 and is then automatically transmitted back 610 to the customer at the dealership. This completes the insurance transaction process in a quick and efficient matter 612.

The automated solution describe here is new and novel. The process delivers unprecedented efficiency through its unique DMS extraction process. Implementation of this process provides the industry with a state-of-the-art point-of-sale solution that is virtually instantaneous and can work in any state. This process and insurance delivery platform are distinctive from all other methods in use today.

As described above, various embodiments of the invention allow car dealers to automatically start a chain of events that solves current industry limitations by electronically referring customer and vehicle information to a licensed entity that can now handle the process in an immediate and automatic fashion.

A range of insurance products, extended service contracts and warranties may be delivered through an Internet/web-based platform that can efficiently and cost-effectively distribute these products to dealerships and/or their customers in the various regulatory climates nationwide.

The Internet/web-based platform can also be adapted to distribute a wide variety of auto-related products and content to the vehicle retailer that can create additional sales, revenue opportunities and efficiencies for dealers. This unique delivery platform may provide an important asset and revenue source to automobile dealers.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications are possible. Those skilled, in the art will appreciate that various adaptations and modifications of the just described preferred embodiment can be configured without departing from the scope and spirit of the invention. Additionally, it is possible to implement embodiments of the invention or some of their features in hardware, programmable devices, firmware, software or a combination thereof. The invention or parts of the invention may also be embodied in a processor-readable storage medium or machine-readable medium such as a magnetic (e.g., hard drive, floppy drive), optical (e.g., compact disk, digital versatile disk, etc), or semiconductor storage medium (volatile and non-volatile). Therefore, it is to be understood that, within the scope of the appended claims, the invention may be practiced other than as specifically described herein.

What is claimed is:

1. A method comprising:
extracting data from a car dealer management system;
transmitting the data to an insurance provider; and
generating an insurance application based on the data received from the dealer management system.

2. The method of claim 1 wherein the insurance application is automatically generated based on the data received from the dealer management system.

3. The method of claim 1 wherein the data includes customer and vehicle data for the insurance application.

4. The method of claim 1 further comprising:
transmitting the insurance application to a customer for approval.

5. The method of claim 4 further comprising:
approving the insurance application; and
transmitting the approved insurance application to the insurance provider.

6. The method of claim 5 wherein approving the insurance application includes a customer signing the insurance application.

7. The method of claim 5 further comprising:
transmitting an evidence of insurance coverage to the dealer when an approved insurance application is received.

8. The method of claim 4 wherein transmitting the insurance application to the customer for approval includes sending an online insurance application to the customer over a web-page.

9. The method of claim 1 wherein the data is transmitted from the dealer to the insurance provider over the Internet.

10. A method comprising:
generating an indicator that a customer needs automobile insurance at a point-of-sale;
extracting the customer's information from a database as a result of the indicator; and
transmitting the extracted customer information to a remote computer for insurance fulfillment.

11. The method of claim 8 further comprising:
receiving customer information at the remote computer;
populating an insurance application; and
transmitting the insurance application to the customer.

12. The method of claim 11 wherein transmitting the insurance application to the customer includes
faxing the insurance application to the dealer for customer approval.

13. The method of claim 11 wherein transmitting the insurance application to the customer includes
generating an on-line insurance application which may be accessed by the customer.

14. The method of claim 11 wherein the insurance application is transmitted to the customer for approval.

15. The method of claim 11 further comprising:
receiving acceptance of the insurance application at the remote computer from the customer;
providing insurance confirmation to the customer upon customer approval of the insurance application.

16. A system comprising:
an indicator to indicate whether a customer needs automobile insurance;
a database of customer information for an automobile dealership; and
a data extraction agent to extract a customer's information if the indicator indicates that the customer needs automobile insurance, the data extraction agent to transmit the extracted information to a remote computer for insurance fulfillment.

17. The system of claim 16 further comprising:
a receiving agent at the remote computer to receive the transmitted customer information; and
an insurance fulfillment subsystem at the remote computer configured to populate an insurance application with the received customer information and transmit the insurance application to the customer.

18. The system of claim 17 wherein transmitting the insurance application to the customer includes
faxing the insurance application to the dealer for customer approval.

19. The system of claim 17 wherein transmitting the insurance application to the customer includes
generating an online insurance application that can be accessed by the customer.

20. The system of claim 17 wherein the insurance fulfillment subsystem is further configured to transmit an insurance confirmation indicator when the customer has approved the insurance application.

21. An apparatus comprising:
a processing system configured to
detect an indicator of whether a customer needs automobile insurance,
access a database of customer information for an automobile dealership,
extract the customer's information from the customer database, if the indicator indicates that the customer needs automobile insurance, and
transmit the extracted information to a remote computer for insurance fulfillment.

22. The apparatus of claim 21 wherein the apparatus is communicatively coupled to the Internet to transmit the extracted customer information.

23. An apparatus comprising:
a processing system configured to
receive a customer's information and request for insurance,
fill-out an insurance application,
transmit the insurance application to the customer, and
transmit confirmation of insurance coverage to the customer upon receipt of approval by the customer.

24. The apparatus of claim 23 wherein the transmission of the insurance application and confirmation of insurance coverage to the customer are done in real-time.

25. A machine-readable medium having one or more instructions for extracting customer information and transmitting the information for insurance fulfillment, which when executed by a processor, causes the processor to perform operations comprising:
detecting an indicator of whether a customer needs automobile insurance;
extracting customer data from a car dealer management system;
transmitting the customer data to an insurance provider.
generating an insurance application based on the customer data received from the dealer management system.
